(19) United States
(12) Patent Application Publication
(10) Pub. No.: US 2026/0258558 A1
(43) Pub. Date: Sep. 3, 2026

(54) INERT GAS INJECTION FOR ELECTROLYSIS

(71) Applicant: Verdagy, Inc., Moss Landing, CA (US)

(72) Inventors: Erik Jan Westling, Oakland, CA (US); Ramin Motamedi, Aptos, CA (US); Gal Mariansky, Morgan Hill, CA (US); Cameron McFerran Hall, Monterey, CA (US); Chase Michael Pilchowski, Los Banos, CA (US); Diego Martinez, Monterey, CA (US); Zhen Sun, Plano, TX (US); Eduardo Martinez Flores, Santa Cruz, CA (US)

(21) Appl. No.: 19/551,178

(22) Filed: Feb. 26, 2026

Related U.S. Application Data
(60) Provisional application No. 63/765,380, filed on Feb. 28, 2025.

(51) Int. Cl. C25B 1/04; C25B 15/08

(52) U.S. Cl. CPC C25B 1/04; C25B 15/08

(57) ABSTRACT

A method to generate hydrogen gas comprises circulating an electrolyte through an electrolyte circuit including an electrochemical cell comprising an anode and a cathode, wherein hydroxide ions in the electrolyte are oxidized at the anode to produce oxygen gas and water in the electrolyte is reduced at the cathode to produce hydrogen gas. The method further includes introducing an inert gas into the electrolyte circuit to dilute a gas phase of the electrolyte circuit.

### CROSS-REFERENCE TO RELATED APPLICATIONS

This application claims the benefit of priority to U.S. Provisional Patent Application Ser. No. 63/765,380, filed on Feb. 28, 2025, entitled “INERT GAS INJECTION FOR ELECTROLYSIS,” the disclosure of which is incorporated herein by reference in its entirety.

### BACKGROUND

A water electrolyzer can be used to produce hydrogen gas as a renewable energy source, offering a sustainable pathway for clean energy generation. An electrolyzer for use in water electrolysis can leverage a variety of different technologies, such as alkaline electrolysis, proton exchange membrane electrolysis, anion exchange membrane electrolysis, solid oxide electrolysis, alkaline exchange membrane electrolysis, or photoelectrochemical water electrolysis.

In an alkaline electrolysis system, for example, an electric current is applied to an electrochemical cell to decompose water from an alkaline electrolyte. At the anode, hydroxide ions are oxidized to generate oxygen gas and water molecules are reduced at the cathode to produce hydrogen gas. Water electrolyzers, including alkaline electrolyzers, can be integrated with a renewable energy source, such as, solar or wind power to produce “green hydrogen.” Alkaline electrolysis can be used for large-scale hydrogen production due to its low cost and high operational efficiency.

### SUMMARY

The present disclosure discloses methods and systems for diluting a gas phase concentration at a specified position within an electrolyte circuit of an electrolyzer system (such as an O₂ gas concentration in an anode chamber of an electrolyzer cell and/or an H₂ gas concentration in a cathode chamber of the electrolyzer cell). For example, the methods and systems can dilute one or both of O₂ gas concentration and H₂ gas concentration so that a gas mixture in the anode chamber is moved away from a lower explosion limit or so that a gas mixture in the cathode chamber is moved away from an upper explosive limit.

In an example, the present disclosure describes a method to generate hydrogen gas, comprising circulating an electrolyte in an electrolyte circuit, wherein the electrolyte circuit includes an electrochemical cell comprising an anode and a cathode, wherein hydroxide ions in the electrolyte are oxidized at the anode to produce oxygen gas and water in the electrolyte is reduced at the cathode to produce hydrogen gas. The example method further includes introducing an inert gas into the electrolyte circuit to dilute a gas phase concentration of the electrolyte circuit.

In another example, the present disclosure describes a system to generate hydrogen gas that includes an electrode chamber having a gas collection space and an electrode chamber input positioned at an end portion of the electrode chamber opposite the gas collection space. The system further comprises an electrolyte circuit configured to circulate an electrolyte through the electrode chamber and an inert gas feed in fluid communication with the electrolyte circuit, wherein the inert gas feed is configured to introduce an inert gas into the electrolyte circuit to dilute a gas phase concentration of the electrolyte circuit.

### BRIEF DESCRIPTION OF THE DRAWINGS

The drawings illustrate generally, by way of example, but not by way of limitation, various embodiments discussed in the present document.

FIG. 1 is a flow diagram of an example method for injection of an inert gas into an electrolyzer.

FIG. 2 is a schematic diagram of an example electrolyzer with inert gas injection at an electrolyte outlet header.

FIG. 3 is a schematic diagram of another example electrolyzer with inert gas injection at an electrolyte feed header.

FIGS. 4A and 4B are schematic diagrams of a portion of an electrolyte circuit within an electrolyzer when in a first configuration wherein inert gas injection into the electrolyte feed header is enabled and a second configuration wherein inert gas injection into the electrolyte feed header is disabled, respectively.

FIG. 5A is an elevation view of an example electrolyte feed header with a conventional vertical orientation.

FIG. 5B is a cross-sectional view of the example electrolyte feed header of taken along line 5B-5B in FIG. 5A.

FIG. 6A is an elevation view of another example electrolyte feed header at an angled orientation.

FIG. 6B is a cross-sectional view of the example electrolyte feed header of taken along line 6B-6B in FIG. 6A.

FIG. 7 is a schematic diagram of another example electrolyzer with inert gas injection at an electrolyte feed header.

FIG. 8 is a cross-sectional view of an example electrolyte feed header that can be used in the electrolyzer of FIG. 7, which includes a gas distribution pipe within a main section of the electrolyte feed header.

FIG. 9 is a cross-sectional view of another example electrolyte feed header that can be used in the electrolyzer of FIG. 7, which includes a gas distribution pipe comprising a sparger in a main section of the electrolyte feed header.

FIG. 10 is a schematic diagram of an example coil tubing connected to an electrolyte feed header for feeding electrolyte solution and inert gas to an electrode chamber of an electrolyzer.

### DETAILED DESCRIPTION

The following detailed description includes references to the accompanying drawings, which form a part of the detailed description. The drawings show, by way of illustration, specific embodiments in which the invention may be practiced. These embodiments, which are also referred to herein as “examples,” are described in enough detail to enable those skilled in the art to practice the invention. The example embodiments may be combined, other embodiments may be utilized, or structural, and logical changes may be made without departing from the scope of the present invention. While the disclosed subject matter will be described in conjunction with the enumerated claims, it will be understood that the exemplified subject matter is not intended to limit the claims to the disclosed subject matter. The following detailed description is, therefore, not to be taken in a limiting sense, and the scope of the present invention is defined by the appended claims and their equivalents.

References in the specification to “one embodiment,” “an embodiment,” “an example embodiment,” etc., indicate that the embodiment described can include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a recited range of values of “about 0.1 to about 5” should be interpreted to include not only the explicitly recited values of about 0.1 and about 5, but also all individual concentrations within the indicated range of values (e.g., 1, 1.23, 2, 2.85, 3, 3.529, and 4, to name just a few) as well as sub-ranges that fall within the recited range (e.g., about 0.1 to about 0.5, about 1.21 to about 2.36, about 3.3 to about 4.9, or about 1.2 to about 4.7, to name just a few). The statement “about X to Y” has the same meaning as “about X to about Y,” ” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. Unless indicated otherwise, the statement “at least one of” when referring to a listed group is used to mean one or any combination of two or more of the members of the group. For example, the statement “at least one of A, B, and C” can have the same meaning as “A; B; C; A and B; A and C; B and C; or A, B, and C,” or the statement “at least one of D, E, F, and G” can have the same meaning as “D; E; F; G; D and E; D and F; D and G; E and F; E and G: F and G; D, E, and F; D, E, and G; D, F, and G; E, F, and G; or D, E, F, and G.” A comma can be used as a delimiter or digit group separator to the left or right of a decimal mark; for example, “0.000,1” ” is equivalent to “0.0001.”

In the methods described herein, the steps can be carried out in any order without departing from the principles of the invention, except when a temporal or operational sequence is explicitly recited. Furthermore, specified steps can be carried out concurrently unless explicit language recites that they be carried out separately. For example, a recited act of doing X and a recited act of doing Y can be conducted simultaneously within a single operation, and the resulting process will fall within the literal scope of the process. Recitation in a claim to the effect that first a step is performed, and then several other steps are subsequently performed, shall be taken to mean that the first step is performed before any of the other steps, but the other steps can be performed in any suitable sequence, unless a sequence is further recited within the other steps. For example, claim elements that recite “Step A, Step B, Step C, Step D, and Step E” shall be construed to mean step A is carried out first, step E is carried out last, and steps B, C, and D can be carried out in any sequence between steps A and E (including with one or more steps being performed concurrent with step A or Step E), and that the sequence still falls within the literal scope of the claimed process. A given step or sub-set of steps can also be repeated.

Furthermore, specified steps can be carried out concurrently unless explicit claim language recites that they be carried out separately. For example, a claimed step of doing X and a claimed step of doing Y can be conducted simultaneously within a single operation, and the resulting process will fall within the literal scope of the claimed process.

The term “about” as used herein can allow for a degree of variability in a value or range, for example, within 10%, within 5%, within 1%, within 0.5%, within 0.1%, within 0.05%, within 0.01%, within 0.005%, or within 0.001% of a stated value or of a stated limit of a range and includes the exact stated value or range.

The term “substantially” as used herein refers to a majority of, or mostly, such as at least about 50%, 60%, 70%, 80%, 90%, 95%, 96%, 97%, 98%, 99%, 99.5%, 99.9%, 99.99%, or at least about 99.999% or more, or 100%.

In addition, it is to be understood that the phraseology or terminology employed herein, and not otherwise defined, is for the purpose of description only and not of limitation. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

Conventional alkaline water electrolysis technology can present an operational challenge when operated at a low current density. As will be appreciated by those having skill in the art, the H₂ gas production rate from a water electrolyzer, such as an alkaline water electrolyzer, is relative and roughly proportional to the current density being supplied to the electrolyzer—e.g., the higher the current density, the higher the H₂ production rate. Therefore, the water electrolysis industry has spent significant resources in trying to maximize the current density at which an electrolyzer cell can operate. That being said, even when designed for moderate to high current density (e.g., at least 0.5 A/cm², for example 1 A/m² or more), there are many scenarios where an electrolyzer may be operated at relatively low current density (e.g., at less than 0.1 A/cm², (100 mA/cm²), for example at 10 ma/cm² or less, 5 mA/cm² or less, 1-5 mA/cm², or even 1 mA/cm² or less. Examples of scenarios when an electrolyzer may be operated at a low current density include, but are not limited to: periods of standby (described in more detail below), system startup, system shutdown, or in situations when the electrolyzer is being operated with a variable current density in response to an external operating parameter (such as in response to the cost of electricity, the relative availability renewable sources of electricity, and/or the relative load on the electrical grid overall) such that the external operating parameter dictates that the electrolyzer be operated at a low current density. For example, when following a fluctuating electricity demand cycle (as is typical during typical hourly, daily, weekly, or seasonal based demand on an electrical grid), the electrolyzer can transition multiple times between a standby mode and an operational mode within a brief period of time.

Operation of an electrolyzer at low current density-either because of variable operation or during periods of standby, system startup, or system shutdown—can provide operational challenges. For example, many electrolyzer cells include a separator, such as a membrane, which is configured to maintain separation between an anode chamber and a cathode chamber within the electrolyzer cell. In many electrolyzer cells, the separator is chosen for selective transmission of specified ions from one chamber to the other. For example, in an alkaline water electrolysis cell, the separator is typically chosen so that hydroxide anions (OH⁻) that are formed by the reduction of water at the cathode to form H₂ gas will pass from the cathode chamber through the separator to the anode chamber where the OH anions can be oxidized to provide O₂ gas. Ideally, the separator would only allow transmission of the specified ions, but practically speaking, no matter how efficient the separator is, there is typically at least some gas permeation from the cathode chamber to the anode chamber (e.g., H₂ gas permeating through the separator and into the anolyte in the anode chamber), from the anode chamber to the cathode chamber (e.g., O₂ gas permeating through the separator and into the catholyte in the cathode chamber), or both. This can be particularly challenging for alkaline water electrolysis because the separation efficiency of separators for alkaline electrolysis (e.g., anion exchange membranes (AEMs)) are known to be low. Thus, gas permeation across the separator and cross-contamination of gases between the anode and cathode chambers can be an issue for alkaline electrolyzers in particular.

Cross-contamination of gases can occur through various mechanisms, including, but not limited to, one or more of: molecular diffusion, pressure-driven convection, electro-osmotic drag, and electrolyte mixing. At higher current densities (e.g., Gas cross-contamination can be particularly challenging with alkaline electrolysis system being operated at a relatively low current density (e.g., at 0.1 A/cm² or less). For example, because the rate of gas production is generally proportional to current density, at a low current density, the rate of gas crossover across the separator can approach, match, or exceed the rate of gas generation at the respective electrodes. The rate of gas crossover can result in a gas mixture in the cathode chamber approaching the upper explosive limit (UEL), a gas mixture in the anode chamber approaching a lower explosive limit (LEL) in the electrochemical cell, and a combination thereof.

The present disclosure addresses this issue by introducing an inert gas into the electrolyzer to dilute the gases in one or both of the anode chamber and the cathode chamber in order to counter cross-contamination by gas crossover. For example, the introduction of the inert gas in accordance with the present disclosure can move the gas mixture in the cathode chamber (also referred to herein as “the cathode chamber gas mixture”) away from the UEL, or can move the gas mixture in the anode chamber (also referred to herein as “the anode chamber gas mixture”) away from the LEL, or both. In particular, the inert gas can be introduced during low current density operation of the electrolyzer, when gas crossover effects may be significant.

As described in more detail below, the inert gas can be introduced though one or more implementation configurations. For example, the inert gas may be introduced at various points during the alkaline water electrolysis, including, but not limited to: at one or more electrolyte outlet headers downstream from the electrochemical cell; at one or more electrolyte feed headers upstream from the electrochemical cell; within one or more electrolyte tanks downstream from the electrochemical cell; within one or more feed lines; and combinations thereof.

As is also described below, the inert gas can be introduced through one or more mechanisms, including, but not limited to: direct injection via an inert gas stream; recirculation within a gas headspace in an electrolyte feed header; distribution through a gas distribution pipe; dispersion via a sparger integrated into an electrolyte feed header; and combinations thereof. However, those skilled in the art will appreciate that the methods and mechanisms for introduction of an inert gas are not limited to the examples described herein. For example, while described with respect to alkaline water electrolysis, those skill in the art will appreciate that the methods and mechanisms described herein can be extended to other electrolysis systems.

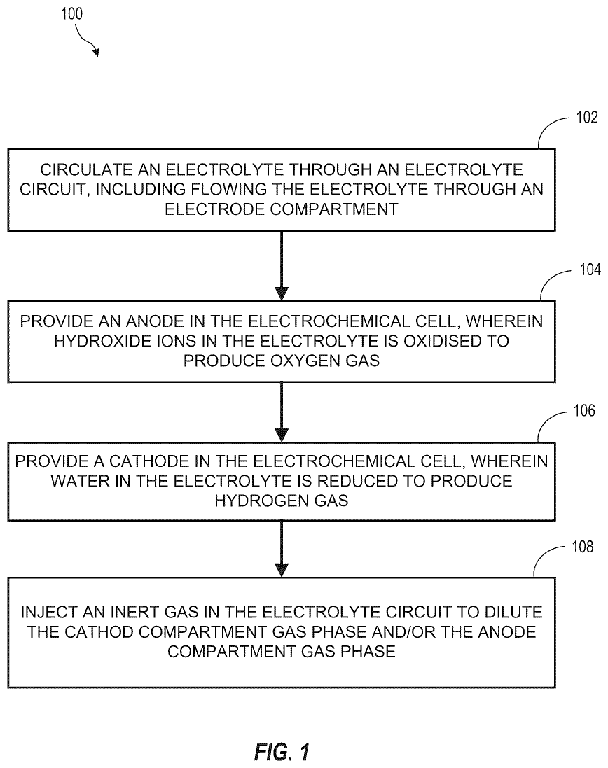

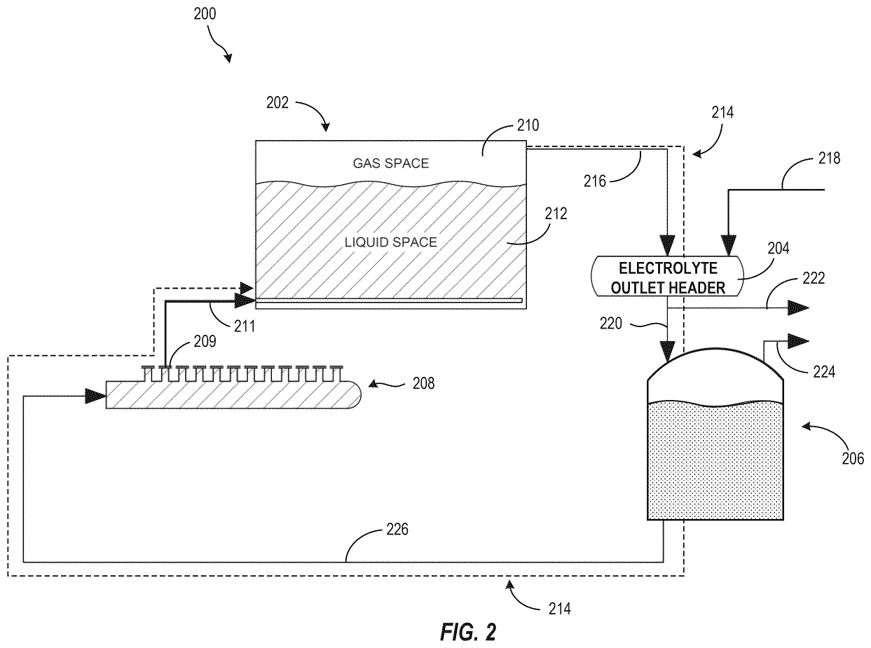

FIG. 1 is a flow diagram of a generic example method 100 for introducing an inert gas into an electrolyzer. The example method 100 includes, at step 102, circulating an electrolyte through an electrolyte circuit, which includes flowing the electrolyte through an electrode chamber of an electrochemical cell. In an example, the electrolyte circuit comprises the electrode chamber, an electrolyte inlet wherein the electrolyte enters the electrode chamber, an electrolyte outlet wherein the electrolyte exits the electrode chamber, and one or more recirculation lines that collectively flows the electrolyte from the electrolyte outlet to the electrolyte inlet. Those having skill in the art will appreciate that there can be additional components or features of the electrolyte circuit. For example, the electrolyte inlet can comprise an electrolyte feed header that is upstream of one or more electrode chambers of one or more cells of the electrolyzer and that is configured to feed electrolyte to the same one or more electrode chambers (e.g., to one or both of the anode and cathode chambers of the same electrolysis cell, and/or to the anode chambers of a plurality of cells, and/or to the cathode chambers of a plurality of cells). In another example, the electrolyte outlet can comprise an electrolyte outlet header that is downstream of one or more electrode chambers of one or more cells of the electrolyzer and that is configured to receive electrolyte from the same one or more electrode chambers (e.g., from one or both of the anode and cathode chambers of the same electrolysis cell, and/or to the anode chambers of a plurality of cells, and/or to the cathode chambers of a plurality of cells). The electrolyte circuit can also optionally include an electrolyte tank that feeds and/or receives electrolyte solution from one or more electrode chambers of the electrolyzer. Further details of one or more example components of the electrolyte circuit are described below, for example with respect to FIG. 2.

In an example, the electrolyte can be alkaline, e.g., comprising KOH, NaOH, LiOH, or NH₄OH. In an example, the alkaline electrolyte can be an aqueous solution with the alkaline component comprising from about 1 wt. % to 40 wt. % of the alkaline electrolyte, for example, about 1 wt. %, about 5 wt. %, about 10 wt. %, about 15 wt. %, about 20 wt. %, about 25 wt. %, about 30 wt. %, or about 40 wt. %.

As described above, in an example, the electrochemical cell can include a cathode chamber and an anode chamber. The method 100 can be implemented in the cathode chamber of the electrochemical cell, in the anode chamber of the electrochemical cell, or combinations thereof.

The method 100 can further include, at step 104, providing an anode in the electrochemical cell, e.g., within the anode chamber of the cell, wherein hydroxide ions (OH⁻) in the electrolyte are oxidized to produce oxygen gas (O₂) and water (H₂O) (also referred to as “the oxygen evolution reaction” or “the OER”). The anode can comprise a variety of different materials, including, but not limited to: a nickel containing material, a cobalt containing material, a manganese containing material, a perovskite oxide containing material, a cerium containing material, a molybdenum containing material, a carbon containing material, and combinations thereof.

The method 100 can also include, at step 106, providing a cathode in the electrochemical cell, e.g., within the cathode chamber of the cell, wherein water (H₂O) in the electrolyte is reduced to produce hydrogen gas (H₂) and hydroxide ions (OH⁻) (also referred to as “the hydrogen evolution reaction” or “the HER”). The cathode can be made from a variety of different materials, including, but not limited to: a nickel containing material, a cobalt containing material, a manganese containing material, a perovskite oxide containing material, a cerium containing material, a molybdenum containing material, a carbon containing material, and combinations thereof. In an example, the cathode can be made from the same or substantially the same material as the anode, or the cathode can be made from a different material. In an example, one or both of the anode and the cathode can be coated with a catalyst, such as a catalyst for the OER that is coated onto one or more surfaces of the anode and/or a catalyst for the HER that is coated onto one or more surfaces of the cathode.

In an example, the anode chamber is separated from the cathode chamber by a separator. In an example, the separator is permeable to ion flow (e.g., allowing flow of OH-ions from the cathode chamber to the anode chamber) but prevents or substantially prevents the flow of other molecule types (e.g., water molecules, O₂ gas, or H₂ gas) between the anode chamber and the cathode chamber. The separator can include various types, including, but not limited to: a polymer-based separator, a ceramic-based separator, a composite separator, an ion-exchange membrane, and the like. Optionally, the anode chamber and cathode chamber can contain two different types of electrolytes.

Next, the method 100 can include, at step 108, injecting an inert gas into the electrolyte circuit to dilute a gas phase of the electrolyte circuit in one or more of: the anode chamber, the cathode chamber, an inlet header, and an outlet header. As used herein, the term “inert gas” refers to a gas that does not react with water (H₂O), O₂ gas, H₂ gas, or OH-ions. The inert gas may also be referred to herein as “the purge gas.” Examples of gases that can be used as the inert gas include, but are not limited to: nitrogen gas (N₂), argon gas (Ar), helium gas (He), carbon dioxide (CO₂), and combinations thereof. The inert gas can be injected into the electrolyte circuit in a variety of different locations and through different mechanisms, which will be discussed in detail with respect to FIGS. 2-10.

The flow rate of the inert gas being injected into the electrolyte circuit can be determined as a function of one or more of: (1) a specified hydrogen to oxygen (HTO) concentration or range of concentrations at one or more locations within the electrolyte circuit; (2) a specified oxygen to hydrogen (OTH) concentration or range of concentrations at one or more locations within the electrolyte circuit; (3) a specified O₂ gas generation rate or range of rates at the anode; (4) a specified H₂ gas generation rate or range of rates at the cathode; (5) an operating current density or range of operating current densities; (6) an in-line O₂ measurement at one or more locations within the electrolyte circuit; (7) an in-line H₂ measurement at one or more locations within the electrolyte circuit. For example, in an electrolyzer system that initially has an HTO concentration of 20,000 ppm in an anode chamber, to achieve a specified HTO concentration of 10,000 ppm, the inert gas flow rate can be determined to be equal to the electrolyzer's O₂ generation rate in the anode. Optionally, the inert gas flow rate can be determined by a feedback or feed-forward control scheme that takes into account an expected or measured gas crossover rate across the separator based on various parameters. These parameters can include, but are not limited to, the electrolyte flowrate, the temperature of the electrolyte within one or both of the electrode chambers, a pressure within one or both of the electrode chambers, separator type, separator size, separator condition, dissolved gas concentration, degree of electrolyte mixing, and combinations thereof.

In an example, after injection of the inert gas into the electrolyte circuit, a cathode chamber gas phase of the electrolyte circuit can comprise from about 1 ppm to about 25,000 ppm of O₂, for example, about 5,000 ppm, about 10,000 ppm, about 15,000 ppm, about 20,000 ppm, or about 25,000 ppm. This concentration of O₂ can be indicative of an OTH that is away from the UEL of an O₂/inert gas/H₂ system. In an example, after injection of the inert gas into the electrolyte circuit, an anode chamber gas phase of the electrolyte circuit can comprise from about 1 ppm to about 20,000 ppm of H₂, for example, about 5,000 ppm, about 10,000 ppm, about 15,000 ppm, or about 20,000 ppm. This concentration of H₂ can be indicative of an HTO that is away from the LEL of a O₂/inert gas/H₂ system.

FIG. 2 is a schematic diagram of one example of a way to inject an inert gas within an electrolyte circuit of an electrolyzer 200 that is configured to produce H₂ gas and/or O₂. In the example shown in FIG. 2, inert gas is injected at an electrolyte outlet header. In an example, the electrolyzer 200 comprises an electrode chamber 202 wherein an electrolyte solution is subjected to an electrochemical reaction (such as the OER or the HER for water electrolysis discussed above). For example, an electrode can be positioned at least partially within the electrode chamber 202 so that the electrode is in contact with the electrolyte solution and a potential is applied to the electrode to drive the electrochemical reaction. The electrolyte and produced gas can flow from the electrode chamber into an electrolyte outlet header 204. In an example, the liquid electrolyte can continue to flow from the electrolyte outlet header 204 to an electrolyte tank 206, from which it can be returned to the inlet of the electrode chamber 202.

As would be understood by those having skill in the art, the electrode chamber 202 shown in FIG. 2 can be either the anode chamber or the cathode chamber of an individual cell of the overall electrolyzer 200. Those having skill in the art will appreciate that the electrolyzer 200 can include a second electrode chamber (not shown in FIG. 2) that is separated from the electrode chamber 202 by a separator such as an ion-exchange membrane (also not shown). The outlet from the second electrode chamber can also be fed into the same electrolyte outlet header 204 or the second electrode chamber can have its own electrolyte outlet header. Similarly, the liquid electrolyte the exits the second electrode chamber can be fed into the same electrolyte tank 206 or the electrolyzer 200 can include a second batch tank for the electrolyte of the second electrode chamber. Those having skill in the art will also appreciate that the other aspects of the electrode chamber 202 described below can be applied to the second electrode chamber that is not shown in FIG. 2.

After an electrolyte solution is fed into the electrode chamber 202 and gas is produced at by the electrochemical reaction at the electrode, within the electrode chamber 202 is a gas collection space 210 and a liquid space 212. Because the produced gas is typically considerably less dense than the electrolyte solution, the gas collection space 210 is typically located vertically above the liquid space 212, as shown in FIG. 2. An electrolyte inlet 211 can feed the electrolyte solution to the electrode chamber 202. In an example, the electrolyte inlet 211 is positioned so that the electrolyte input location is generally at a vertical position that is generally at an opposite vertical end of the electrode chamber 202 from the gas collection space 210 (e.g., with the gas collection chamber 210 being located generally at a vertical top end of the electrode chamber 202 and the electrolyte inlet 211 feeding into a vertical bottom end of the electrode chamber 202). In an example, an electrolyte feed header 208 can be included to feed the electrolyte solution to the electrolyte inlet 211. In an example, the electrolyte feed header 208 can include an outlet port 209 that is fluidly connected to the electrolyte inlet 211 into the electrode chamber 202.

In an example, the electrolyzer 200 can be operated in four modes: (1) standby, (2) ramp-up, (3) operation, and (4) ramp-down. In an example, the electrolyzer 200 includes an electrolyte circuit 214 that carries the electrolyte solution from the outlet of the electrode chamber 202 (e.g., the electrolyte outlet header 204) back to the electrolyte inlet 211 into the electrode chamber 202, for example by circulating the electrolyte solution to the electrolyte feed header 208.

At the electrode chamber 202, electrolysis of water can take place. In one example, the electrode chamber 202 can be an anode chamber of the electrolyzer 200 where OH-ions in the electrolyte are oxidized to produce O₂ gas via the OER. In such an example, the produced O₂ gas rises within the electrode chamber 202 and collects to form the gas collection space 210, while the leftover electrolyte solution (which also includes H₂O produced by the OER) forms the liquid space 212. In another example, the electrode chamber 202 can be a cathode chamber of the electrolyzer 200 where H₂O in the electrolyte is reduced to produce H₂ gas via the HER. In this example, the produced H₂ gas rises within the electrode chamber 202 and collects to form the gas collection space 210, while the leftover electrolyte solution (which also includes OH-produced by the HER) forms the liquid space 212.

An outlet stream 216 from the electrode chamber 202 can be transferred to the electrolyte outlet header 204. Like the electrode chamber 202 itself, the outlet stream 216 can include a gas phase, a liquid phase, and combinations thereof. In an example, the outlet stream 216 can include the electrolyte solution used in the electrochemical reaction, O₂ gas, H₂ gas, dissolved O₂ in the electrolyte solution, dissolved H₂ in the electrolyte solution, and combinations thereof. As shown in FIG. 2, in an example, the outlet stream 216 from the electrode chamber 202 and the electrolyte outlet header 204 can form part of the electrolyte circuit 214.

In the example shown in FIG. 2, an inert gas 218 is introduced into the electrolyte circuit 214 to dilute the O₂ concentration away from the UEL and/or to dilute the H₂ concentration away from the LEL. In the example of FIG. 2, the inert gas 218 is introduced into the electrolyte circuit 214 at the electrolyte outlet header 204, which can be accomplished using a variety of methods, including, but not limited to, using a sparger, using a Venturi injector, using a static mixer, using a bubble column, using a gas diffusion reactor, using a nozzle for direct injection, and combinations thereof. After introduction of the inert gas 218, the outlet stream 216 is diluted by the inert gas 218 to form a dilute stream 220 (i.e., wherein one or both of the O₂ concentration and the H₂ concentration is reduced compared to that of the outlet stream 216). As can be seen in FIG. 2, the dilute stream 220 can also form part of the electrolyte circuit 214. In an example, the dilute stream 220 is fed to the electrolyte tank 206. In an example, O₂ gas and/or H₂ gas can be extracted along with the inert gas from the dilute stream 220 by an inline gas extraction line 222 and/or from the electrolyte tank 206 by a tank gas extraction line 224. The extracted gas in one or both of the gas extraction lines 222, 224 can then be captured, packaged, and transported to an end user. In an example, the electrolyte solution is recycled back to the electrode chamber 202 through a recycle line 226, which can form a part of the electrolyte circuit 214 (as shown in FIG. 2). The recycle line 226 can feed the electrolyte solution into the electrolyte feed header 208, which, as described above, can then feed the electrolyte solution to the electrode chamber inlet 211.

Injection of the inert gas 218 into the electrolyte circuit 214 at the electrolyte outlet header 204, as in the example electrolyzer 200 of FIG. 2, can allow for utilizing an existing electrolyte outlet header 204 without significant modification to a standard electrolyte outlet header 204 design. The injection of the inert gas 218 at the electrolyte outlet header 204 can also allow for an increased volume of the inert gas 218 to be injected into the electrolyte circuit 214.

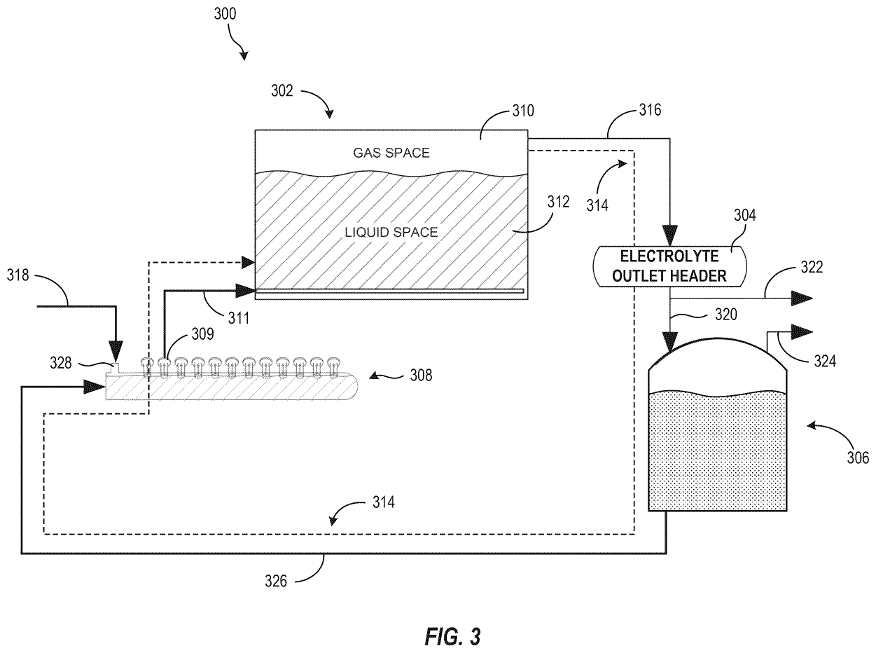

FIG. 3 is a schematic diagram of another example of an electrolyzer 300 that provides for injection of an inert gas into an electrolyte circuit. The electrolyzer 300 is similar to the electrolyzer 200 of FIG. 2 and includes many of the same structures, which have been given similar reference numbers for ease of understanding. As can be seen in FIG. 3, the electrolyzer 300 also includes an electrode chamber 302 (which can be either the anode chamber or the cathode chamber of the electrolyzer 300). An electrolyte solution can be fed into the electrode chamber 302 via an electrolyte inlet 311, which can be fed from an outlet port 309 from an electrolyte feed header 308. Within the electrode chamber 302, produced gas (e.g., O₂ gas produced by the OER or H₂ gas produced by the HER) rises to a gas collection space 310, while the liquid electrolyte solution collects in a liquid space 312. An electrolyte circuit 314 carries electrolyte solution from an outlet of the electrode chamber 302 to the electrolyte inlet 311. For example, the electrolyte circuit 314 can include an outlet stream 316 that exits the electrode chamber 302 and is in fluid communication with an electrolyte outlet header 304. The electrolyte outlet header 304 can be in fluid communication with an electrolyte tank 306 via a tank feed stream 320, and electrolyte can flow from the electrolyte tank 306 to the electrolyte feed header 308 via a recycle line 326. Gas (such as produced O₂ gas, produced H₂ gas, and/or inert gas) can be extracted from the intermediate stream 320 by an inline gas extraction line 322 and/or from the electrolyte tank 306 by a tank gas extraction line 324 for capturing, packaging, and transporting of one or more of the gases to an end user. The electrolyzer 300 can be consistent with the electrolyzer 200 discussed in FIG. 2, and operation of the various components of electrolyzer 200 can be combined with descriptions of FIG. 3.

The primary difference between the electrolyzer 200 of FIG. 2 and the electrolyzer 300 of FIG. 3 is that instead of injecting an inert gas into the electrolyte outlet header 304 (as is the case for the inert gas 218 that is injected into the electrolyte outlet header 204 in FIG. 2), an inert gas 318 is instead introduced into the electrolyte feed header 308, such as via an inert gas injection port 328. As shown in FIG. 3, the electrolyte feed header 308 can be upstream from the electrode chamber 302 and can receive electrolyte solution from the electrolyte circuit 314, such as from the electrolyte tank 306 via the recycle line 326. In an example, the electrolyte feed header 308 can comprise an outlet port 309 that extends radially from a longitudinal axis of the electrolyte feed header 308. The outlet port 309 can provide for fluid communication between the electrolyte feed header 308 and the electrolyte inlet 311 of the electrode chamber 302. As can be seen in FIG. 3, the electrolyte feed header 308 can include a plurality of outlet ports 309, which can each be fluidically connected to a separate corresponding electrode chamber within the electrolyzer 300 to distribute electrolyte amongst the electrode chambers 302.

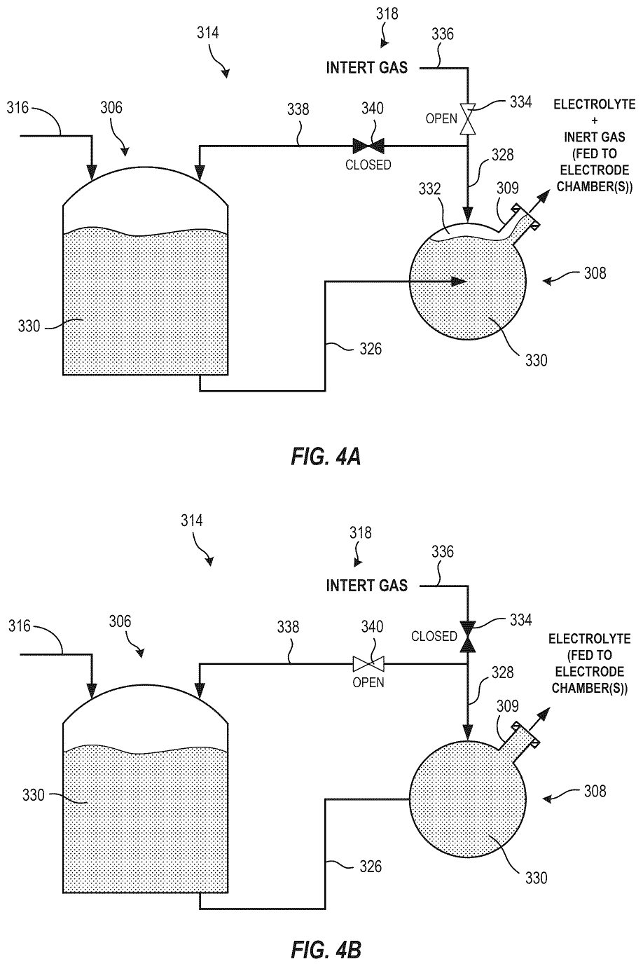

FIGS. 4A and 4B are schematic diagrams of an example configuration for an electrolyte circuit 314 that can be part of an electrolyzer (such as the electrolyzer 300 of FIG. 3, which is why the electrolyte circuit 314 and many of its components are given the same reference numbers as in FIG. 3). The portion of the electrolyte circuit 314 shown in FIGS. 4A and 4B includes the electrolyte feed header 308 that feeds an electrolyte solution 330 to one or more electrolysis cells (such as the electrode chambers 302 of the electrolyzer 300 in FIG. 3). The electrolyte circuit 314 also includes the electrolyte tank 306 that holds the electrolyte solution 330 and feeds it to the electrolyte header 308 via the recycle line 326. The electrolyte solution 330 can be fed to the electrolyte tank 306 by the tank feed stream 320, which can originate from the outlet from one or more electrolysis electrode chambers (as described above with respect to FIG. 3).

The electrolyte circuit 314 can switch between a first configuration that allows for introduction of the inert gas 318 into the feed header 308 (FIG. 4A) and a second configuration that prevents injection of the inert gas 318 into the feed header 308 (FIG. 4B). The electrolyte feed header 308 is shown in a cross-section view in FIGS. 4A and 4B. The electrolyte feed header 308 can comprise one or more outlet ports 309 extending radially from a longitudinal axis of the electrolyte feed header 308. Each outlet port 309 can fluidly connect the electrolyte feed header 308 to one or more electrode chambers in the electrolyzer 300 to distribute the electrolyte solution 330 amongst the one or more electrode chambers. The electrolyte feed header 308 can comprise a gas headspace 332 extending at least partially along the longitudinal axis of the electrolyte feed header 308, at least when the inert gas 318 is being fed to the electrolyte feed header 308. The gas headspace 332 can allow injection and flow of the inert gas 318 along the longitudinal axis of the electrolyte feed header 308. As discussed in more detail below, the outlet port 309 can be positioned so that they are oriented off vertical (e.g., angled relative to a vertical axis of the electrolyte feed header 308) to enable the gas headspace 332 to form at the top of the electrolyte feed header 308. The gas headspace 332 can allow for the inert gas 318 injected through an inert gas inlet 328 to distribute along the length of the electrolyte feed header 308 within the gas headspace 332 so that the inert gas 318 will mix with the electrolyte solution 330 and such that the electrolyte solution and the inert gas can flow as a mixed phase stream of liquid and gas out of the outlet port 309. Optionally, the gas headspace 332 can allow for the inert gas 318 to be injected at any location along the electrolyte feed header 308, and the gas headspace 332 can distribute the inert gas along the length of the electrolyte feed header 308, before exiting via the outlet port 309.

When in the first configuration for insert gas injection, illustrated in FIG. 4A, an inert gas feed valve 334 located on an inert gas feed line 336 is in an open position so that the inert gas 318 can be injected into the electrolyte feed header 308 via the inert gas inlet 328, so that the inert gas 318 can form the gas headspace 332. In an example, the first configuration with the inert gas feed valve 334 in the open position for inert gas injection into the electrolyte feed header 308 can be used during a standby mode of the electrolyzer 300, such as during ramp-up of the electrolyzer 300 during or right before start-up or during ramp-down of the electrolyzer 300 during or right after shutdown.

When in the second configuration for inert gas shutoff, illustrated in FIG. 4B, the inert gas feed valve 334 is in a closed position so that the inert gas 318 is not injected into the electrolyte feed header 308. Any gas that had been located within the gas headspace 332 can be vented (e.g., through the outlet port 309) and the gas headspace 332 can become filled up with the electrolyte solution 330. In such an example, the electrolyte 330 can exit the outlet port 309 as a liquid stream instead of the mixed gas and liquid stream when in the first configuration. In an example, the electrolyte circuit 314 can also include a tank gas line 338 that is fed into the electrolyte tank 306, wherein the tank gas line 338 includes a tank gas valve 340. As shown in FIG. 4A, when in the first configuration the tank gas valve 340 can be in a closed position so that the inert gas 318 that is intended to flow into the electrolyte feed header 308 does not flow into the electrolyte tank 306. However, when in the second configuration wherein the inert gas feed valve 334 is in the closed position, the tank gas valve 340 can be in an open position so that inert gas can be directed into the electrolyte tank 306 via the tank gas line 338. Optionally, inert gas can also be injected into feed lines for the electrolyte solution 330 (such as the electrolyte inlet 311 into the electrode chamber 302 in FIG. 3).

In another example, both the inert gas feed valve 334 and the tank gas valve 340 can be closed so that no inert gas is introduced into the electrolyte circuit 314. For example, both the inert gas feed valve 334 and the tank gas valve 340 can be closed during an operation mode of the electrolyzer 300.

Injection of the inert gas 318 into the electrolyte circuit 314 at the electrolyte feed header 308 (and then into the electrode chamber 302) can allow for the inert gas bubbling up the electrode chamber 302 to sweep up any gas in the cell formed during the electrochemical reaction, and prevent the gas mixture in the gas space 310 of the electrode chamber 302 from approaching the UEL or the LEL.

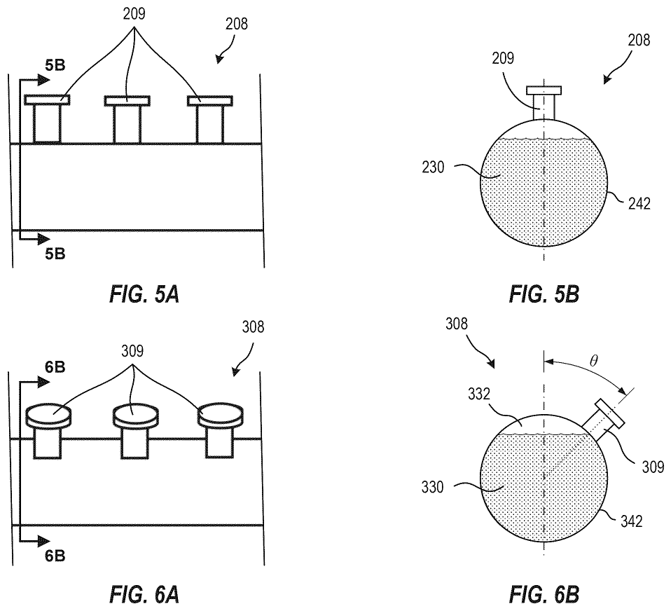

As mentioned above, the one or more outlet ports of the electrolyte feed header extend radially outward from the feed header. In the example electrolyzer 200 shown in FIG. 2, the outlet ports 209 are shown as being vertical or substantially vertical with respect to the main portion of the electrolyte feed header 208. FIGS. 5A and 5B show closer views of a portion of the vertically oriented feed header 208. FIG. 5A shows a side view and FIG. 5B shows a cross-sectional view of the electrolyte feed header 208. As can be seen in FIGS. 5A and 5B, the outlet ports 209 are oriented vertically or substantially vertically, e.g., with a center axis of each outlet port 209 being aligned or substantially aligned with a vertical axis of a main section 242 of the electrolyte feed header 208 that holds the electrolyte solution 230.

As is also mentioned above, each of the one or more outlet ports can also be angled off vertical relative to the main section of the electrolyte feed header, for example as is shown for the electrolyte feed header 308 of the example electrolyzer 300 shown in FIGS. 3, 4A, and 4B. FIGS. 6A and 6B show closer views of a portion of the off vertical feed header 308. FIG. 6A shows a side view and FIG. 6B shows a cross-sectional view of the electrolyte feed header 308. As can be seen in FIGS. 6A and 6B, the outlet ports 309 are angled relative to vertical, e.g., so that a center axis of each outlet port 309 is angled at an angle θ relative to a vertical axis of a main section 342 of the electrolyte feed header 308 that holds the electrolyte solution 330. The off vertical outlet ports 309 can allow the formation of the gas headspace 332 at the vertical top of the main section 342 while still allowing the mixed flow of both the electrolyte solution 330 and the inert gas out of the outlet port 309.

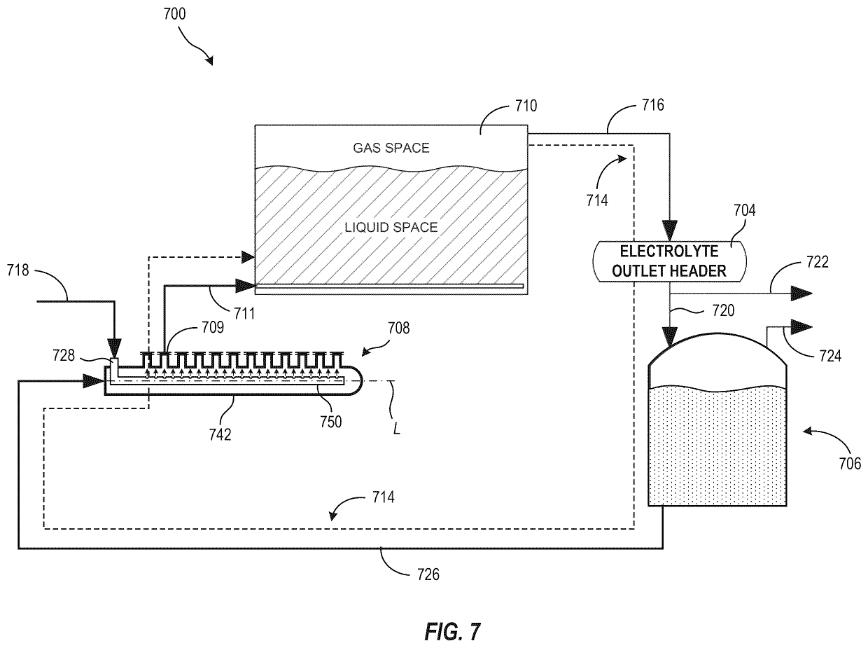

FIG. 7 is a schematic diagram of an electrolyzer 700 with inert gas injection at an electrolyte feed header 708, similar to the electrolyzer 300 of FIG. 3. For example, the electrolyzer 700 also includes an electrode chamber 702 (which can be either the anode chamber or the cathode chamber of the electrolyzer 700). An electrolyte solution can be fed into the electrode chamber 702 via an electrolyte inlet 711, which can be fed from an electrolyte feed header 708. An electrolyte circuit 714 carries electrolyte solution from an outlet of the electrode chamber 702 to the electrolyte inlet 711. Like the electrolyte circuit 314 of the electrolyzer 300, the electrolyte circuit 714 can include an outlet stream 716 that exits the electrode chamber 702 and is in fluid communication with an electrolyte outlet header 704. The electrolyte outlet header 704 can be in fluid communication with an electrolyte tank 706 via a tank feed stream 720, and electrolyte can flow from the electrolyte tank 706 to the electrolyte feed header 708 via a recycle line 726. Gas (such as produced O₂ gas, produced H₂ gas, and/or inert gas) can be extracted from the intermediate stream 720 by an inline gas extraction line 722 and/or from the electrolyte tank 706 by a tank gas extraction line 724 for capturing, packaging, and transporting of one or more of the gases to an end user.

Similar to the electrolyzer 300 of FIG. 3, an inert gas 718 can be introduced into the electrolyte feed header 708, such as via an inert gas injection port 728. As shown in FIG. 3, the electrolyte feed header 708 can be upstream from the electrode chamber 702 and can receive electrolyte solution from the electrolyte circuit 714, such as from the electrolyte tank 706 via the recycle line 726. The electrolyte feed header 708 also comprises an outlet port 709 that is in fluid communication with the electrolyte inlet 711 of the electrode chamber 702. The electrolyte feed header 708 can include a plurality of outlet ports 709 that are each fluidically connected to a separate corresponding electrode chamber 702 within the electrolyzer 700 to distribute electrolyte amongst the electrode chambers 702.

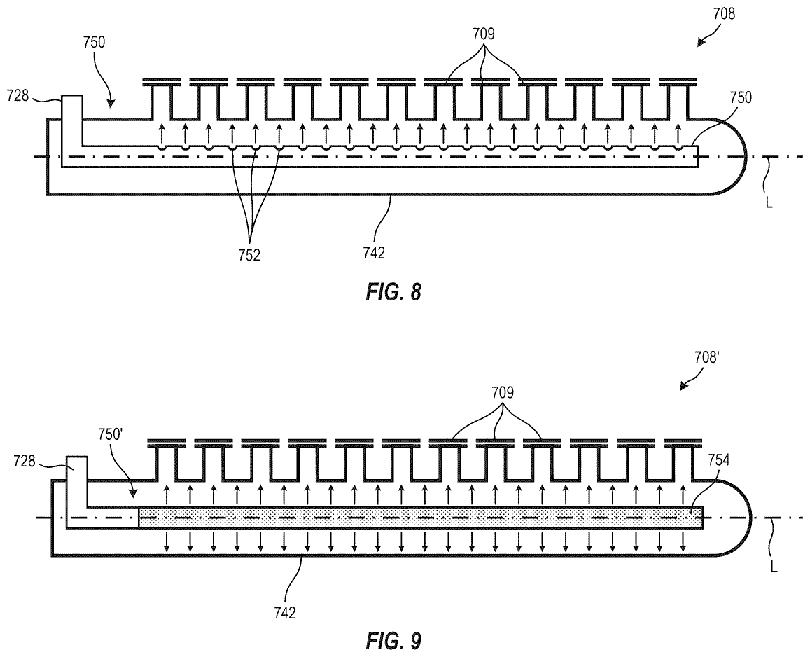

In an example, the electrolyte feed header 708 also comprises a gas distribution pipe 750 extending at least partially within an interior of and along a longitudinal axis L of a main section 742 of the electrolyte feed header 708. FIG. 8 shows a cross-sectional elevation view of the electrolyte feed header 708 to show further detail of the gas distribution pipe 750. The gas distribution pipe 750 is in fluid communication with the inert gas injection port 728 is configured to inject the inert gas 718 into the main section 742 of the electrolyte feed header 708 so that the inert gas 718 will mix with the electrolyte solution and form a mixed phase stream that is fed into the electrode chamber 702 through a corresponding one of the one or more outlet ports 709.

In an example, the gas distribution pipe 750 comprises a plurality of holes 752 distributed longitudinally along the length of the gas distribution pipe 750 (e.g., in the same direction as the longitudinal axis L). The plurality of holes 752 can be configured to disperse the inert gas 718 as it is injected into the main section 742 of the electrolyte feed header 708. In an example, the plurality of holes 752 are positioned along a substantial portion of the length of the gas distribution pipe 750 (e.g., from near the proximal end adjacent to the inert gas injection port 728 (on the left side of FIG. 8) to near the distal end of the gas distribution pipe 750 (on the right side of FIG. 8) so that injection of the inert gas 718 is distributed across a substantial portion of the length of the main section 742, which in turn can provide for the mixed phase fluid (e.g., electrolyte solution and inert gas) exiting through the plurality of outlet ports 709 and into the corresponding electrode chambers 702 of the electrolyzer 700. The plurality of holes 752 can be distributed in a variety of configurations, including, but not limited to: all or substantially all of the holes 752 being directed in one direction (e.g., upward as shown in FIG. 8); a first portion of the holes 752 being directed in a first direction and a second portion of the holes 752 being directed in a second direction that is different from the first direction (for example with the first direction being generally vertically upward and the second direction being in a generally opposite direction facing vertically downward), and optionally with a third portion of the holes 752 being directed in a third direction that is different from the first and second directions, or more (e.g., a forth portion being directed in a fourth direction, a fifth portion being directed in a fifth direction, etc.). Optionally, the plurality of holes 752 can be distributed evenly or substantially evenly (e.g., with consistent spacing between adjacent holes 752), in particular along the length of the gas distribution pipe 750, or the holes 752 can be irregularly distributed along the length of the gas distribution pipe 750. In an example, groupings of one or more holes 752 can be located at regular intervals along the gas distribution pipe 750 that coincide with the locations of the outlet ports 709 from the electrolyte feed header 708.

In another example, shown in FIG. 9, a gas distribution pipe 750′ within the electrolyte feed header 708′ comprises a sparger 754 extending at least partially along the longitudinal axis L of the main section 742 of the electrolyte feed header 708′. Similar to the holes 752 in the gas distribution pipe 750 of FIG. 8, the sparger 754 can be configured to inject the inert gas 718 into the main section 742 of the electrolyte feed header 708′. In an example, the sparger 754 comprises small perforations or pores through which bubbles of the inert gas 718 can pass, enabling efficient gas-liquid contact. In an example, the sparger 754 comprises multiple small perforations, slots, pores, or porous surfaces to distribute the inert gas 718 into the electrolyte solution. Different types of spargers can be used with the gas distribution pipe 750′ in the electrolyte feed header 708′, including, but not limited to: perforated pipe spargers, tube spargers, porous spargers, ceramic diffuser spargers, membrane spargers, venturi spargers, and the like.

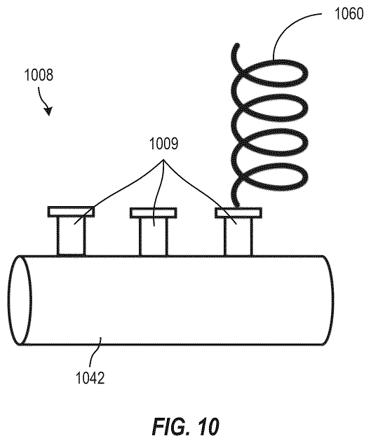

FIG. 10 is a schematic diagrams of an electrolyte feed header 1008, which can be similar or identical to any of the electrolyte feed headers 208, 308, 708, or 708′ described above and can be used in any one of the electrolyzers described herein. Similar to the earlier electrolyte feed headers, the electrolyte feed header 1008 includes a main section 1042 with one or more outlet ports 1009 that extend radially outward from the main section 1042. The electrolyte feed header 1008 also includes a coil tubing 1060 that is fluidically connected to a corresponding one of the one or more outlet ports 1009 at one end and can be connected to an inlet into a corresponding electrode chamber (which can be similar or identical to any one of the electrode chambers 202, 302, or 702 described above. Although FIG. 10 is shown with only one coil tubing 1060 connected to one of the outlet ports 1009, the electrolyte feed header 1008 can include a plurality of outlet ports 1009 (as shown in FIG. 10) and each of the outlet ports 1009 can be fluidly connected to a corresponding electrode chamber through a separate corresponding coil tubing 1060. The electrode chambers can include an anode chamber, a cathode chamber, and combinations thereof. The coil tubing 802 can be generally oriented in a vertical direction as shown in FIG. 10, which can prevent or reduce the likelihood plugging of the coil tubing 1060. Such plugging can occur by several mechanism, such as blocking, restriction, partial blocking, or narrowing of the coil tubing 1060. These conditions can arise from the presence of debris, contaminants, impurities, bubbles resulting from inert gas introduction, and combinations thereof. The plugging of the coil tubing 1060 can result in pressure drop in the electrolyte circuit, increased flow resistance, and combinations thereof. A generally vertical direction of coil travel of the coil tubing 1060 can mitigate plugging by an inert gas bubble because the bubble's buoyancy will impel the gas bubble to travel upward through the coil tubing 1060. This reduces or minimizes the chances of inert gas bubbles blocking or restricting electrolyte flow through the coil tubing 1060. The coil tubing 1060 can be constructed from a variety of materials, such as stainless steel, nickel alloys, titanium alloys, polymers, composites, and combinations thereof.

### EXAMPLES

Various embodiments of the present invention can be better understood by reference to the following Examples which are offered by way of illustration. The present invention is not limited to the Examples given herein.

### Example 1

Nitrogen gas (N₂) was introduced as an inert gas into an alkaline electrolysis electrolyzer operating at a current density of less than 0.1 A/cm². The electrolyzer was operated in three modes: (1) a standby mode wherein the current density supplied to the is very low (e.g., 0.001-0.005 A/cm²) and O₂ gas and H₂ gas is not being produced (at least not in large quantities); (2) a ramp-up mode wherein the electrolyzer is being transitioned from the standby mode to full operation, e.g., wherein the current density is being increased up to the full 100% current density, but has yet to reach the 100% production; and (3) operation mode, e.g., wherein the electrolyzer is operating at or near 100% production. Nitrogen gas was injected into a cathode electrolyte outlet header downstream from an electrochemical cell at three different rates, corresponding to the three modes—in the standby mode, nitrogen gas was injected at 12 standard liters per minute (SLPM); in the ramp-up mode, nitrogen gas was injected at 50 SLPM; and in the operation mode, nitrogen gas flow was turned off (0 SLPM). The composition of gas at the cathode was sampled through a sample port at the cathode outlet header and the results are discussed below.

### Example 2

Nitrogen gas (N₂) was introduced as an inert gas into an alkaline electrolysis electrolyzer operating at a current density of less than 0.1 A/cm². The electrolyzer was operated in the same three modes as in EXAMPLE 1, but instead of injecting the nitrogen gas into the cathode electrolyte outlet header, the nitrogen gas was injected into an anode electrolyte outlet header downstream from the electrochemical cell. As in EXAMPLE 1, the injection rate of the nitrogen gas into the anode electrolyte outlet header depended on the mode-35 SLPM for the standby mode; 200 SLPM for the ramp-up mode; and with no nitrogen gas injection when in the operation mode (i.e., 0 SLPM). The composition of gas at the anode was sampled through a sample port at the anode outlet header and the results are discussed below.

### Example 3

The alkaline electrolysis electrolyzer of EXAMPLE 2, with nitrogen gas injection into the anode electrolyte outlet header. However, different nitrogen gas injection rates were used-30 SLPM for the standby mode and for the ramp-up mode, and with no nitrogen gas injection (i.e., 0 SLPM) when in the operation mode. The composition of gas at the anode was sampled through a sample port at the anode outlet header and the results are discussed below.

### Example 4

Nitrogen gas (N₂) was introduced as an inert gas into an alkaline electrolysis electrolyzer operating at a current density of less than 0.1 A/cm². The electrolyzer was operated in the same three modes as in EXAMPLES 1-3. Instead of injection of the nitrogen gas into one of the outlet headers, as in EXAMPLES 1-3, the nitrogen gas was injected into an anode electrolyte feed header, through a sparger, upstream from a corresponding electrochemical cell. As with the previous examples, the injection rate for the nitrogen gas depended on the mode of operation-15 SLPM for the standby mode and for the ramp-up mode; and no nitrogen gas was injected (0 SLPM) for the operation mode. The composition of gas at the anode was sampled through a sample port at the anode outlet header and the results are discussed below.

Table 1 below shows the O₂ concentration (in ppm) measured from the sample port of the cathode outlet header and the H₂ gas concentration (also in ppm) measured from the sample port of the anode outlet header in EXAMPLES 1-4. Table 1 also lists the percentage of the UEL for each O₂ concentration and the percentage of the LEL for each H₂ gas concentration.

TABLE 1

| | Example | Example | Example | Example |
|---|---|---|---|---|
| | 1 | 2 | 3 | 4 |
| Standby N₂ flow rate | 12 | 35 | 30 | 15 |
| (SLPM) | | | | |
| Ramp-up N₂ flow rate | 50 | 200 | 30 | 15 |
| (SLPM) | | | | |
| Operation N₂ flow | 0 | 0 | 0 | 0 |
| rate (SLPM) | | | | |
| Standby mode | 139 | — | — | — |
| cathode O₂ (ppm) | (0.278% | | | |
| | UEL) | | | |
| Ramp-up mode peak | 258 | — | — | — |
| cathode O₂ (ppm) | (0.518% | | | |
| | UEL) | | | |
| Standby mode anode | — | 4,000 | 3,200 | 6,00 |
| H₂ (ppm) | | (10% | (8% | (15% |
| | | LEL) | LEL) | LEL) |
| Ramp-up mode peak | — | 22,000 | 9,600 | 12,000 |
| anode H₂ (ppm) | | (55% | (24% | (30% |
| | | LEL) | LEL) | LEL) |

As can be seen in Table 1, in EXAMPLE 1, when the electrolyzer was in standby mode, the O₂ concentration measured from the cathode outlet header was 139 ppm at an N₂ flow rate of 12 SLPM. This translated to 0.278% of the UEL of 500 ppm for O₂ in an O₂/N₂/H₂ mixture. During the ramp-up mode, the ramp-up N₂ flow rate was increased to 50 SLPM, and the peak measured O₂ concentration at the cathode outlet header was 258 ppm, or 0.518% of the UEL.

In EXAMPLE 2, when the electrolyzer was in standby mode, the H₂ concentration measured from the anode outlet header was 4,000 ppm at a standby N₂ flow rate of 35 SLPM. This translated to 10% of the LEL of 40,000 ppm for H₂ in an O₂/N₂/H₂ mixture. During ramp-up mode, the ramp-up N₂ flow rate was increased to 200 SLPM, and the peak measured H₂ concentration at the cathode outlet header was 22,000 ppm, or 55% of the LEL.

In EXAMPLE 3, when the electrolyzer was in standby mode, the H₂ concentration measured from the anode outlet header was 3,200 ppm at a standby N₂ flow rate of 30 SLPM. This translated to 8% of the LEL of 40,000 ppm of H₂ in a O₂/N₂/H₂ mixture. During ramp-up mode, the ramp-up N₂ flow rate was maintained at 30 SLPM, and the peak measured H₂ concentration at the anode outlet header was 9,600 ppm, or 24% of the LEL.

In EXAMPLE 4, the nitrogen gas was introduced through a sparger in the anode electrolyte feed header. When the electrolyzer was in standby mode, the H₂ concentration measured from the anode outlet header was 6,000 ppm at a standby N₂ flow rate of 15 SLPM. This translated to 15% of the LEL of 40,000 ppm for H₂ in an O₂/N₂/H₂ mixture. During ramp-up mode, the ramp-up N₂ flow rate was kept constant at 30 SLPM, and the peak measured H₂ concentration at the anode outlet header was 12,000 ppm, or 30% of the LEL.

EXAMPLES 1-4 show that introduction of a nitrogen inert gas in an electrolyte circuit of an alkaline electrolysis electrolyzer can dilute the cross-contamination of gases in the cathode and anode chambers at a low current density. The dilution by the nitrogen inert gas in the electrolyte circuit can reduce concentration of O₂ away from the UEL in the cathode chamber and reduce the concentration of H₂ away from the LEL in the anode chamber. In addition, by comparing EXAMPLE 3 and EXAMPLE 4, an increase in the nitrogen inert flow rate in standby mode from 15 to 30 SLPM can further reduce the concentration of H₂ in the anode chamber, from 6,000 ppm to 3,200 ppm during the standby mode.

In conclusion, introduction of an inert gas into an electrolyte circuit of an electrolyzer operating at a low current density can dilute the concentration of O₂ below the UEL and the concentration of H₂ below the LEL. The introduction of an inert gas into the electrolyte circuit can be implemented for both the cathode chamber and anode chamber of an electrochemical cell to dilute O₂ and H₂, respectively.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72 (b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. A method to generate hydrogen gas, comprising:
circulating an electrolyte in an electrolyte circuit, wherein the electrolyte circuit includes an electrochemical cell comprising an anode and a cathode,
wherein hydroxide ions in the electrolyte are oxidized at the anode to produce oxygen gas and water in the electrolyte is reduced at the cathode to produce hydrogen gas; and
introducing an inert gas into the electrolyte circuit to dilute a gas phase concentration of the electrolyte circuit.

2. The method of claim 1, wherein the inert gas comprises at least one of N₂, Ar, He, and CO₂.

3. The method of claim 1, wherein the gas phase concentration of the electrolyte circuit comprises a concentration of O₂ gas in the cathode chamber or a concentration of H₂ gas in the anode chamber, or both, and wherein: (1) the concentration of O₂ gas in the cathode chamber is from about 1 ppm to about 25,000 ppm; or (2) the concentration of H₂ gas in the anode chamber is from about 1 ppm to about 20,000 ppm; or both (1) and (2).

4. The method of claim 1, wherein the introducing of the inert gas into the electrolyte circuit comprises injecting the inert gas downstream of the electrochemical cell.

5. The method of claim 4, wherein the electrolyte circuit comprises an electrolyte outlet header downstream of the electrochemical cell, and wherein the introducing of the inert gas into the electrolyte circuit comprises injecting the inert gas into the electrolyte outlet header.

6. The method of claim 1, wherein the introducing of the inert gas into the electrolyte circuit comprises injecting the inert gas upstream of the electrochemical cell.

7. The method of claim 6, wherein the electrolyte circuit comprises an electrolyte feed header upstream of the electrochemical cell, and wherein the introducing of the inert gas into the electrolyte circuit comprises injecting the inert gas into the electrolyte feed header.

8. The method of claim 6, wherein the electrolyte feed header comprises a header main section and an outlet port extending radially from a longitudinal axis of the header main section, wherein a gas headspace forms at least partially along the longitudinal axis of the header main section, and wherein the gas headspace enables flow of the inert gas along the longitudinal axis of the header main section.

9. The method of claim 8, wherein the gas headspace is at least partially filled with the inert gas when the inert gas is injected into the header main section.

10. The method of claim 7, wherein the electrolyte feed header comprises a header main section and a gas distribution pipe extending at least partially along a longitudinal axis of the header main section, wherein the gas distribution pipe enables injection of the inert gas into the header main section.

11. The method of claim 1, wherein the electrolyte circuit further comprises an electrolyte tank, wherein the introduction of the inert gas into the electrolyte circuit comprises injecting the inert gas into the electrolyte tank.

12. A system to generate hydrogen gas, comprising:
an electrode chamber comprising:
a gas collection space; and
an electrode chamber input positioned at an end portion of the electrode chamber opposite the gas collection space;
an electrolyte circuit configured to circulate an electrolyte through the electrode chamber; and
an inert gas feed in fluid communication with the electrolyte circuit, wherein the inert gas feed is configured to introduce an inert gas into the electrolyte circuit to dilute a gas phase concentration of the electrolyte circuit.

13. The system of claim 12, wherein the inert gas comprises at least one of N₂, Ar, He, and CO₂.

14. The system of claim 12, wherein the electrode chamber comprises a cathode chamber and an anode chamber.

15. The system of claim 14, wherein the inert gas is introduced into the electrolyte circuit at a specified flow rate such that: (1) an O₂ gas concentration in the cathode chamber is from about 1 ppm to about 25,000 ppm when the inert gas is introduced into the electrolyte circuit; or (2) an H₂ gas concentration in the anode chamber is from about 1 ppm to about 20,000 ppm when the inert gas is introduced into the electrolyte circuit; or both (1) and (2).

16. The system of claim 12, wherein the electrolyte circuit comprises an electrolyte outlet header downstream from the electrode chamber, wherein the inert gas feed is in fluid communication with the electrolyte outlet header and is configured to inject the inert gas into the electrolyte outlet header.

17. The system of claim 12, wherein the electrolyte circuit comprises an electrolyte feed header upstream from the electrode chamber, wherein the inert gas feed is in fluid communication with the electrolyte feed header and is configured to inject the inert gas into the electrolyte feed header.

18. The system of claim 17, wherein the electrolyte feed header comprises:
a header main section through which flows the electrolyte; and
an outlet port extending radially from the header main section, wherein the outlet port is fluidly connected to the electrode chamber,
wherein a gas headspace forms at least partially along a longitudinal axis of the header main section, wherein the gas headspace enables flow of the inert gas along the longitudinal axis of the header main section.

19. The system of claim 17, wherein the electrolyte feed header comprises a header main section and a gas distribution pipe extending at least partially along a longitudinal axis of the header main section, wherein the gas distribution pipe is configured to inject the inert gas into the header main section.

20. The system of claim 19, wherein the gas distribution pipe comprises a plurality of holes distributed along a longitudinal axis of the gas distribution pipe through which the inert gas can flow to inject the inert gas into the header main section.

21. The system of claim 19, wherein the gas distribution pipe comprises a sparger extending at least partially along a longitudinal axis of the gas distribution pipe, wherein the sparger is configured to inject the inert gas into the header main section.
